(19) United States
(12) Patent Application Publication
(10) Pub. No.: US 2026/0023033 A1
(43) Pub. Date: Jan. 22, 2026

(54) IMAGING DEVICE AND METHOD FOR DETERMINING IMAGING POSITION

(71) Applicant: SHIMADZU CORPORATION, Kyoto-shi (JP)

(72) Inventors: Kana KOJIMA, Kyoto-shi (JP); Yasuyuki KEYAKI, Kyoto-shi (JP); Daisuke HARADA, Kyoto-shi (JP)

(21) Appl. No.: 19/251,574

(22) Filed: Jun. 26, 2025

(30) Foreign Application Priority Data
Jul. 17, 2024 (JP) 2024-114294

(51) Int. Cl. G01N 23/046

(52) U.S. Cl. CPC G01N 23/046

(57) ABSTRACT

Provided is an imaging device that makes it possible to easily determine an imaging position when a detection unit having a large imaging region is switched to a detection unit having a small imaging region to capture an image of a subject.

This imaging device 100 includes: a detection unit 20a configured to capture a captured image 101 of a subject 200; a detection unit 20b having an imaging region smaller than an imaging region of the detection unit 20a and configured to capture a captured image 102 of the subject 200; and a control unit 90. The control unit 90 performs control for generating a superimposed image 103 in which an imaging region image 104 showing the imaging region of the detection unit 20b is superimposed on the captured image 101 and control for displaying the superimposed image 103 on a display unit 70.

### 1. FIELD OF THE INVENTION

The present invention relates to an imaging device and a method for determining an imaging position.

### 2. DESCRIPTION OF THE RELATED ART

Imaging devices are conventionally known (see Japanese Patent Application Publication No. 2023-161504, for example).

Japanese Patent Application Publication No. 2023-161504 discloses an X-ray imaging device (imaging device). This X-ray imaging device includes an X-ray tube and a detector (detection unit) and is configured to capture an image of a subject by emitting X-rays from the X-ray tube and detecting X-rays that have passed through the subject with use of the detector.

### SUMMARY OF THE INVENTION

A conventional X-ray imaging device (imaging device) such as the imaging device described in Japanese Patent Application Publication No. 2023-161504 may include a plurality of detectors (detection units) having different imaging regions, and switch between the plurality of detectors while capturing images of a subject. If the plurality of detectors are switched while capturing images of a subject, it is possible to obtain more information about the subject compared with a case where images of the subject are captured with use of only one detector. However, when a detector having a large imaging region is switched to a detector having a small imaging region to capture an image of a subject, it may be necessary to adjust the imaging position such that an imaging target part of the subject is included in the imaging region of the detector having the small imaging region. In this case, it is difficult to grasp whether or not the imaging target part of the subject is included in the imaging region of the detector having the small imaging region by merely grasping the positional relationship between the subject and the detector having the small imaging region, and accordingly, it is difficult to determine the imaging position. Therefore, it is desired to make it possible to easily determine the imaging position.

The present invention was made to solve the above problem, and an object of the present invention is to provide an imaging device and a method for determining an imaging position that make it possible to easily determine an imaging position when a detection unit having a large imaging region is switched to a detection unit having a small imaging region to capture an image of a subject.

In order to achieve the above object, an imaging device according to a first aspect of the present invention includes: a first detection unit configured to capture a first X-ray image of a subject; a second detection unit having an imaging region smaller than an imaging region of the first detection unit and configured to capture a second X-ray image of the subject; and a control unit, wherein the control unit performs control for generating a superimposed image in which an imaging region image showing the imaging region of the second detection unit is superimposed on the first X-ray image, and control for displaying the superimposed image on a display unit.

In order to achieve the above object, a method for determining an imaging position according to a second aspect of the present invention is a method for determining an imaging position in an imaging device including a first detection unit configured to capture a first X-ray image of a subject and a second detection unit having an imaging region smaller than an imaging region of the first detection unit and configured to capture a second X-ray image of the subject, the method including: generating a superimposed image by superimposing an imaging region image showing the imaging region of the second detection unit on the first X-ray image; and displaying the superimposed image on a display unit.

In order to achieve the above object, an imaging device according to a third aspect of the present invention includes: a first detection unit configured to capture a first X-ray image of a subject; a second detection unit having an imaging region smaller than an imaging region of the first detection unit and configured to capture a second X-ray image of the subject; and a control unit, wherein the control unit performs control for generating a superimposed image in which the second X-ray image is superimposed on the imaging region of the second detection unit in the first X-ray image, and control for displaying the superimposed image.

In the imaging device according to the first aspect described above and the method for determining an imaging position according to the second aspect described above, a superimposed image in which the imaging region image showing the imaging region of the second detection unit or the second X-ray image is superimposed on the first X-ray image is generated, and the superimposed image is displayed on the display unit as described above. Also, in the imaging device according to the third aspect described above, a superimposed image in which the second X-ray image is superimposed on the imaging region of the second detection unit in the first X-ray image is generated, and the superimposed image is displayed on the display unit as described above. Accordingly, a user can easily grasp whether or not an imaging target part of the subject is included in the imaging region of the second detection unit having the small imaging region based on the superimposed image displayed on the display unit. Therefore, it is possible to easily determine the imaging position when the first detection unit having the large imaging region is switched to the second detection unit having the small imaging region to capture an image of the subject.

If the imaging target part of the subject is not included in the second X-ray image, it is difficult to find the imaging target part of the subject from the second X-ray image, and accordingly, it is difficult to determine the imaging position. However, in the imaging device according to the first aspect described above, the method for determining an imaging position according to the second aspect described above, and the imaging device according to the third aspect described above, the imaging position can be easily determined as described above because the superimposed image is displayed on the display unit, and this is very effective when the imaging target part of the subject is not included in the second X-ray image.

### BRIEF DESCRIPTION OF THE DRAWINGS

FIG. 1 is a schematic diagram showing an overall configuration of an imaging device according to an embodiment.

FIG. 2 is a block diagram of the imaging device according to the embodiment.

FIG. 3 is a diagram showing image capturing performed using a detection unit having a large imaging region according to the embodiment.

FIG. 4 is a diagram showing an image captured using the detection unit having the large imaging region according to the embodiment.

FIG. 5 is a diagram showing image capturing performed using a detection unit having a small imaging region according to the embodiment.

FIG. 6 is a diagram showing an image captured using the detection unit having the small imaging region according to the embodiment.

FIG. 7 is a diagram showing a superimposed image according to the embodiment.

FIG. 8 is a diagram showing a change in the position of an imaging region in the superimposed image along with a change in the position of a subject according to the embodiment.

FIG. 9 is a diagram showing superimposed images generated by superimposing the imaging region on tomographic images according to the embodiment.

FIG. 10 is a diagram for describing calculation of the size of the imaging region according to the embodiment.

FIG. 11 is a flowchart showing a method for determining an imaging position according to the embodiment.

FIG. 12 is a diagram showing generation of a superimposed image according to a variation of the embodiment.

### DESCRIPTION OF THE PREFERRED EMBODIMENTS

The following describes an embodiment of the present invention with reference to the drawings.

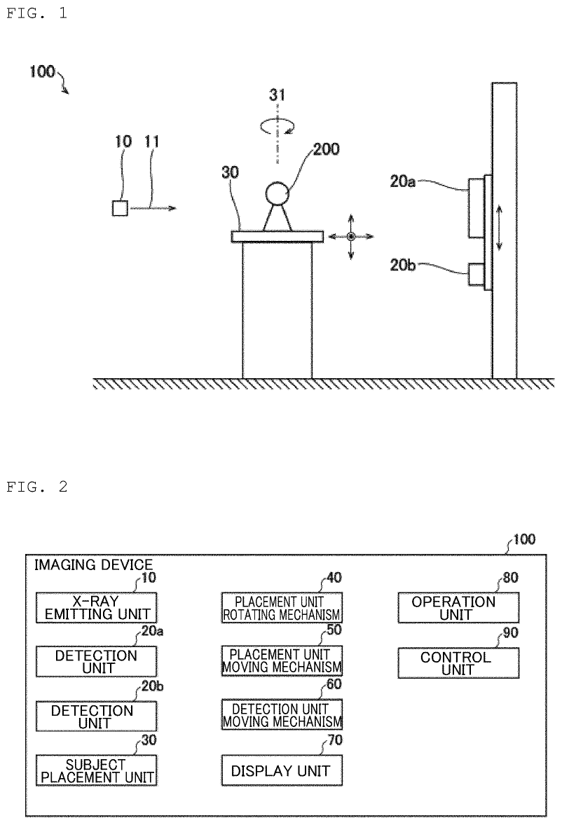

The following describes a configuration of an imaging device 100 according to an embodiment of the present invention with reference to FIGS. 1 to 10.

### Overall Configuration of Imaging Device

As shown in FIG. 1, the imaging device 100 is a device configured to capture an image of a subject 200. More specifically, the imaging device 100 is an X-ray imaging device configured to capture an image of the subject 200 with use of X-rays 11. The imaging device 100 captures an image of the subject 200 with use of X-rays 11 to obtain an X-ray image (a CT image, a tomographic image, or the like) of the subject 200. The imaging device 100 is used for nondestructive tests, for example.

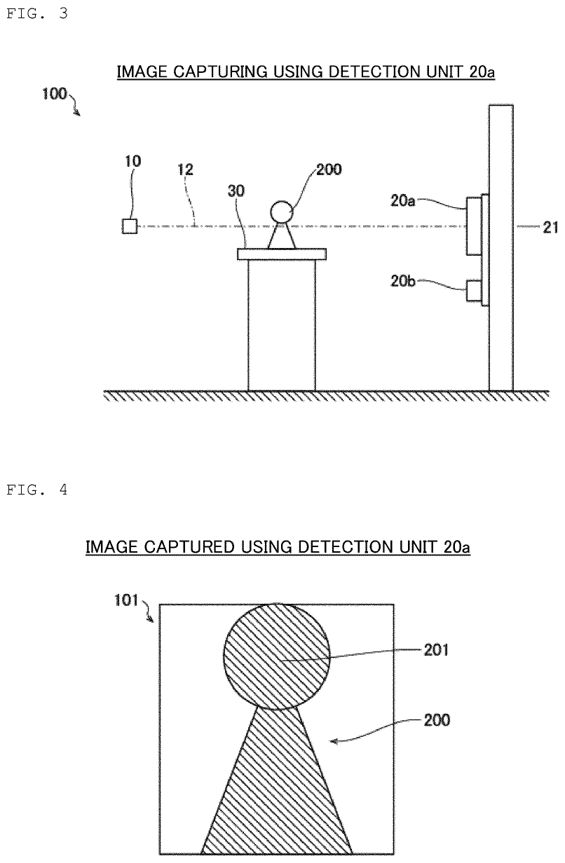

As shown in FIGS. 1 and 2, the imaging device 100 includes an X-ray emitting unit 10, detection units 20a and 20b, a subject placement unit 30, a placement unit rotating mechanism 40, a placement unit moving mechanism 50, a detection unit moving mechanism 60, a display unit 70, an operation unit 80, and a control unit 90. Note that the detection units 20a and 20b are examples of a “first detection unit” and a “second detection unit” in the claims, respectively.

The X-ray emitting unit 10 is configured to emit X-rays 11 toward the subject 200 that is placed on the subject placement unit 30. The X-ray emitting unit 10 includes an X-ray tube in which X-rays 11 are generated when a high voltage is applied, and a collimator that adjusts an irradiation field of the X-rays 11 generated in the X-ray tube. The X-ray emitting unit 10 faces the detection unit 20a or 20b via the subject placement unit 30. The X-ray emitting unit 10, the subject placement unit 30, and the detection unit 20a or 20b are aligned in a horizontal direction.

The detection unit 20a (20b) is configured to detect X-rays 11 (electromagnetic waves) that have been emitted from the X-ray emitting unit 10 and passed through the subject 200. The X-rays 11 emitted from the X-ray emitting unit 10 pass through the subject 200 and are incident on a detection surface of the detection unit 20a (20b). The detection unit 20a (20b) is configured to convert the X-rays 11 incident on the detection surface to electrical signals (detection signals) and output the electrical signals to the control unit 90. The detection unit 20a (20b) is an FPD (Flat Panel Detector), for example. The detection unit 20a (20b) includes a plurality of conversion elements (not shown) arranged in a matrix and pixel electrodes (not shown) respectively arranged on the plurality of conversion elements.

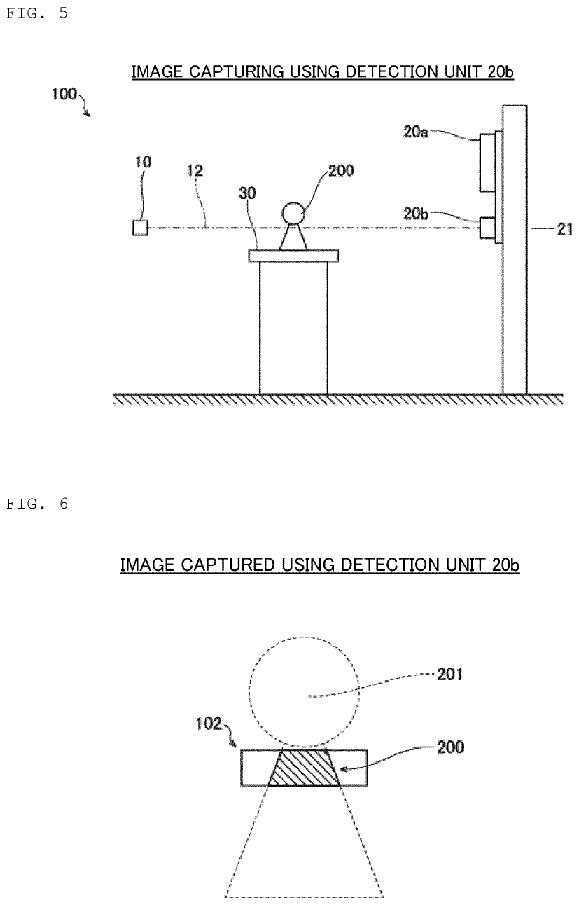

The detection unit 20a is provided to obtain a captured image 101 (see FIG. 4) of the subject 200. The captured image 101 is an X-ray image. The detection unit 20a has an imaging region that is larger than an imaging region of the detection unit 20b. That is to say, the detection unit 20a is larger than the detection unit 20b in both the width and the height, or one of the width and the height of the detection unit 20a is the same as that of the detection unit 20b, but the other of the width and the height of the detection unit 20a is larger than that of the detection unit 20b. Also, the detection unit 20a has a resolution lower than that of the detection unit 20b. That is to say, the detection unit 20a has a pixel density lower than that of the detection unit 20b. Note that the captured image 101 is an example of a “first X-ray image” in the claims.

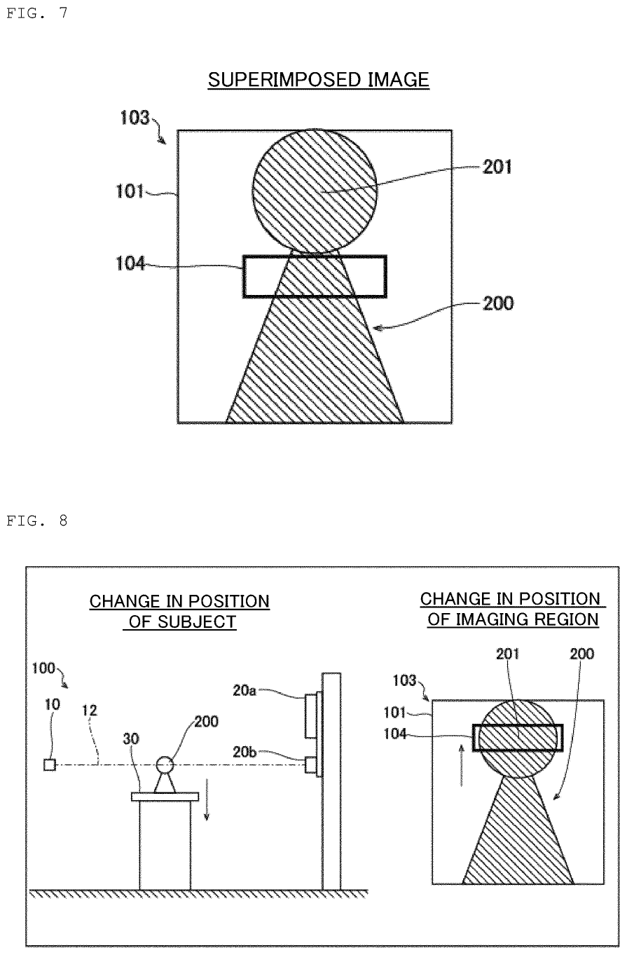

The detection unit 20b is provided to obtain a captured image 102 (see FIG. 6) of the subject 200. The captured image 102 is an X-ray image. The imaging region of the detection unit 20b is smaller than the imaging region of the detection unit 20a. That is to say, the detection unit 20b is smaller than the detection unit 20a in both the width and the height, or one of the width and the height of the detection unit 20b is the same as that of the detection unit 20a, but the other of the width and the height of the detection unit 20b is smaller than that of the detection unit 20a. Also, the resolution of the detection unit 20b is higher than the resolution of the detection unit 20a. That is to say, the pixel density of the detection unit 20b is higher than the pixel density of the detection unit 20a. Note that the captured image 102 is an example of a “second X-ray image” in the claims.

The subject placement unit 30 on which the subject 200 is placeable is disposed between the X-ray emitting unit 10 and the detection unit 20a or 20b. The subject placement unit 30 is constituted by a stage on which the subject 200 is placed. The subject placement unit 30 is configured to be movable in three directions, i.e., in an up-down direction, a horizontal direction parallel to a direction in which an optical axis 12 of the X-ray emitting unit 10 (see FIGS. 3 and 5) extends, and a horizontal direction orthogonal to the direction in which the optical axis 12 of the X-ray emitting unit 10 extends.

The placement unit rotating mechanism 40 is configured to rotate the subject placement unit 30 relative to the X-ray emitting unit 10 and the detection unit 20a (20b). Thus, the placement unit rotating mechanism 40 is configured to change an imaging angle of the subject 200. The placement unit rotating mechanism 40 is configured to rotate the subject placement unit 30 about: a rotation axis 31 extending in the up-down direction. The placement unit rotating mechanism 40 includes a motor for rotating the subject placement unit 30, a decelerator, and the like.

The placement unit moving mechanism 50 is configured to move the subject placement unit 30 relative to the X-ray emitting unit 10 and the detection unit 20a (20b). This enables adjustment of the imaging position. The placement unit moving mechanism 50 is configured to move the subject placement unit 30 in three directions, i.e., in the up-down direction, the horizontal direction parallel to the direction in which the optical axis 12 of the X-ray emitting unit 10 (see FIGS. 3 and 5) extends, and the horizontal direction orthogonal to the direction in which the optical axis 12 of the X-ray emitting unit 10 extends. The placement unit moving mechanism 50 includes a motor for moving the subject placement unit 30, a decelerator, and the like.

The detection unit moving mechanism 60 is configured to move the detection units 20a and 20b. This makes it possible to switch between the detection units 20a and 20b to capture an image of the subject 200. The detection unit moving mechanism 60 is configured to move the detection units 20a and 20b in the up-down direction. The detection unit moving mechanism 60 includes a motor for moving the detection units 20a and 20b, a decelerator, and the like.

The display unit 70 includes a monitor, for example, and displays an X-ray image or the like. The operation unit 80 accepts various operations relating to the imaging device 100. The control unit 90 is configured to perform overall control of the imaging device 100. The control unit 90 is constituted by a processor such as a CPU (Central Processing Unit), a GPU (Graphics Processing Unit), an FPGA (Field-Programmable Gate Array), or a circuitry, and memories such as a ROM (Read Only Memory) and a RAM (Random Access Memory), for example.

When an image is to be captured with use of the detection unit 20a, the detection unit 20a is moved by the detection unit moving mechanism 60 such that the optical axis 12 of the X-ray emitting unit 10 coincides with the center of the detection unit 20a as shown in FIG. 3. At this time, the detection unit 20a is moved by the detection unit moving mechanism 60 such that the optical axis 12 of the X-ray emitting unit 10 is located at a position corresponding to the middle of the height of the detection unit 20a. When X-rays 11 are emitted from the X-ray emitting unit 10 toward the subject 200, the detection unit 20a detects X-rays 11 that have passed through the subject 200 and outputs detection signals corresponding to the detected X-rays 11 to the control unit 90. The control unit 90 performs control for generating an X-ray image such as the captured image 101 shown in FIG. 4 based on the detection signals output from the detection unit 20a. When a CT image is to be generated as the X-ray image, images of the subject 200 are captured at a plurality of imaging angles set in advance while the imaging angle of the subject 200 is changed by rotating the subject placement unit 30 with use of the placement unit rotating mechanism 40. The control unit 90 performs control for generating a plurality of projection images (X-ray images) corresponding to the plurality of imaging angles based on detection signals output from the detection unit 20a with respect to the plurality of imaging angles. Then, the control unit 90 performs control for generating a CT image (X-ray image) showing a three-dimensional structure of the subject 200 by executing reconstruction processing on the plurality of projection images. Also, the control unit 90 performs control for generating a tomographic image showing a cross section of the subject 200 from the CT image. An image of any cross section of the CT image can be generated as the tomographic image.

When an image is to be captured with use of the detection unit 20b, the detection unit 20b is moved by the detection unit moving mechanism 60 such that the optical axis 12 of the X-ray emitting unit 10 coincides with the center of the detection unit 20b as shown in FIG. 5. At this time, the detection unit 20b is moved by the detection unit moving mechanism 60 such that the optical axis 12 of the X-ray emitting unit 10 is located at a position corresponding to the middle of the height of the detection unit 20b. The detection unit 20a and the detection unit 20b are configured to capture images of the subject 200 at equivalent height positions 21. When X-rays 11 are emitted from the X-ray emitting unit 10 toward the subject 200, the detection unit 20b detects X-rays s 11 that have passed through the subject 200 and outputs detection signals corresponding to the detected X-rays 11 to the control unit 90. The control unit 90 performs control for generating an X-ray image such as the captured image 102 shown in FIG. 6 based on the detection signals output from the detection unit 20b. Note that FIG. 6 schematically shows parts of the subject 200 that are not included in the captured image 102 with broken lines to facilitate understanding. When a CT image is to be generated as the X-ray image, the CT image is generated similarly to the case where the detection unit 20a is used. That is to say, the control unit 90 performs control for generating a plurality of projection images (X-ray images) corresponding to a plurality of imaging angles based on detection signals output from the detection unit 20b with respect to the plurality of imaging angles, and performs control for generating a CT image (X-ray image) showing a three-dimensional structure of the subject 200 by executing reconstruction processing on the plurality of projection images.

The imaging device 100 is capable of switching between the detection units 20a and 20b while capturing images of the subject 200. This makes it possible to obtain more information about the subject 200 compared with a case where images of the subject 200 are captured with use of only the detection unit 20a or 20b. However, when the detection unit 20a having the large imaging region is switched to the detection unit 20b having the small imaging region to capture an image of the subject 200, it may be necessary to adjust the imaging position such that an imaging target part of the subject 200 is included in the imaging region of the detection unit 20b having the small imaging region. For example, assume that a user who checked the captured image 101 wants to further check a part 201 of the subject 200 (circular part of the subject 200) and intends to obtain an image of the part 201, which is the imaging target part, of the subject 200 with use of the detection unit 20b. In this case, if an image of the subject 200 is captured while merely switching from the detection unit 20a to the detection unit 20b, the part 201 of the subject 200, i.e., the imaging target part will not be included in the captured image 102 as shown in FIG. 6, and accordingly, it is necessary to adjust the imaging position such that the part 201 is included in the imaging region of the detection unit 20b.

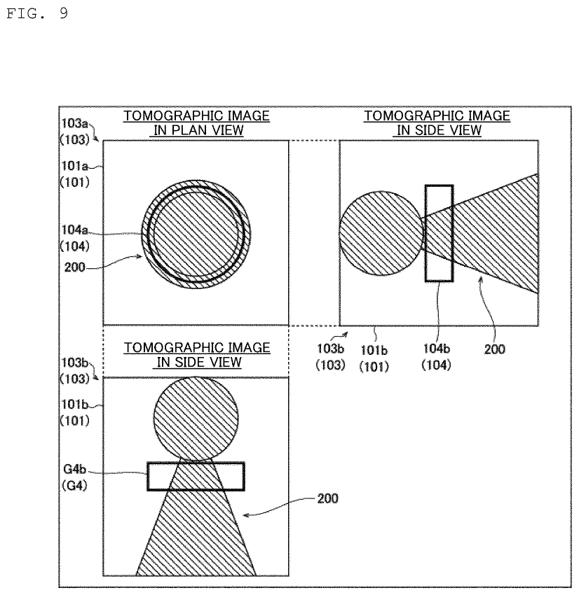

Therefore, in the present embodiment, the control unit 90 is configured to perform the following control to assist the user in adjusting the imaging position. The control unit 90 is configured to perform control for generating a superimposed image 103 in which an imaging region image 104 showing the imaging region of the detection unit 20b is superimposed on the captured image 101 as shown in FIG. 7, and perform control for displaying the superimposed image 103 on the display unit 70. More specifically, the control unit 90 is configured to perform control for generating the superimposed image 103 by superimposing the imaging region image 104 on the captured image 101 such that the center of the captured image 101 coincides with the center of the imaging region image 104. The imaging region image 104 shows the imaging region with a frame line. The frame line as the imaging region image 104 is shown in a color (e.g., green) different from the color of the captured image 101, which is an X-ray image (monochrome image).

Also, in the present embodiment, the control unit 90 is configured to perform control for changing the position of the imaging region image 104 on the captured image 101 in the superimposed image 103 so as to track a change in a relative position of the subject 200 relative to the detection unit 20b as shown in FIG. 8. More specifically, the control unit 90 is configured to perform control for changing the position of the imaging region image 104 on the captured image 101 in the superimposed image 103 so as to track a change in the relative position of the subject 200 relative to the detection unit 20b due to movement of the subject placement unit 30 accompanied by movement of the subject 200.

For example, if the part 201 of the subject 200, which is the imaging target part, is not inside the imaging region shown by the imaging region image 104 in the superimposed image 103 displayed on the display unit 70, the user moves the subject placement unit 30 with use of the operation unit 80. The control unit 90 performs control for moving the subject placement unit 30 with use of the placement unit moving mechanism 50 based on an operation signal from the operation unit 80. At this time, the subject 200 moves accompanying the movement of the subject placement unit 30, and accordingly, the relative position of the subject 200 relative to the detection unit 20b changes. Also, the control unit 90 performs control for changing the position of the imaging region image 104 on the captured image 101 in the superimposed image 103 displayed on the display unit 70 in real time in response to the subject placement unit 30 being moved by the placement unit moving mechanism 50. If the subject placement unit 30 is moved in the up-down direction by the placement unit moving mechanism 50, the position of the imaging region image 104 on the captured image 101 is changed in real time in a direction corresponding to the up-down direction in the superimposed image 103 displayed on the display unit 70. If the subject placement unit 30 is moved in a horizontal direction by the placement unit moving mechanism 50, the position of the imaging region image 104 on the captured image 101 is changed in real time in a direction corresponding to the horizontal direction in the superimposed image 103 displayed on the display unit 70.

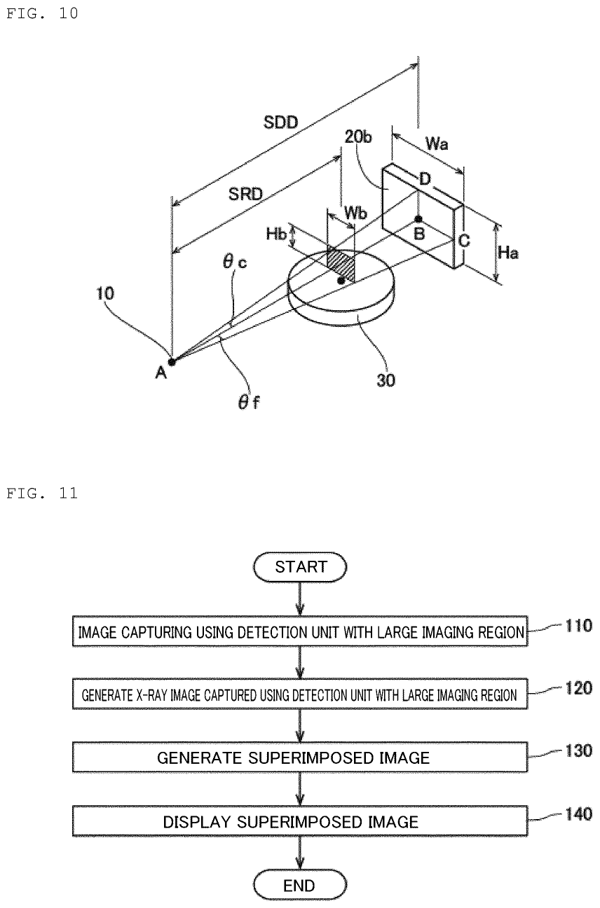

Also, in the present embodiment, the captured image 101 (101a, 101b, 101c) is a tomographic image, which is an X-ray image, as shown in FIG. 9. The control unit 90 is configured to perform control for displaying, on the display unit 70, the superimposed image 103 (103a, 103b, 103c) in which the imaging region image 104 (104a, 104b, 104c) having a shape corresponding to a cross section shown by the tomographic image as the captured image 101 is superimposed on the captured image 101 (101a, 101b, 101c).

For example, a captured image 101a is a tomographic image in a plan view in which the subject 200 is viewed from above. In this case, the control unit 90 performs control for displaying, on the display unit 70, a superimposed image 103a in which an imaging region image 104a shown as a circular frame line is superimposed on the captured image 101a. Also, for example, a captured image 101b is a tomographic image in a side view in which the subject 200 is viewed in a horizontal direction parallel to the direction in which the optical axis 12 of the X-ray emitting unit 10 extends. In this case, the control unit 90 performs control for displaying, on the display unit 70, a superimposed image 103b in which an imaging region image 104b shown as a rectangular frame line is superimposed on the captured image 101b. Also, for example, a captured image 101c is a tomographic image in a side view in which the subject 200 is viewed in a horizontal direction orthogonal to the direction in which the optical axis 12 of the X-ray emitting unit 10 extends. In this case, the control unit 90 performs control for displaying, on the display unit 70, a superimposed image 103c in which an imaging region image 104c shown as a rectangular frame line is superimposed on the captured image 101c. Also, the control unit 90 performs control for displaying the superimposed images 103a, 103b, and 103c at the same time on the display unit 70.

FIG. 10 is a diagram for describing calculation of the size of the imaging region of the detection unit 20b. When the width of the detection unit 20b is represented by Wa, the height of the detection unit 20b is represented by Ha, a distance from the X-ray emitting unit 10 to the detection unit 20b is represented by SDD, a fan angle is represented by θf, and a cone angle is represented by θc, the control unit 90 is configured to perform control for obtaining the fan angle θf using the following formula (1) and obtaining the cone angle θc using the following formula (2). Note that the fan angle θf is the angle formed between a side AB and a side AC of a right-angled triangle ABC of which the point A corresponds to the position of the X-ray emitting unit 10, the point B corresponds to the center of the detection unit 20b, and the point C corresponds to a position opposite to the point B in the width direction of the detection unit 20b on an edge of the detection unit 20b in the width direction. The cone angle θc is the angle formed between the side AB and a side AD of a right-angled triangle ABD of which the point A corresponds to the position of the X-ray emitting unit 10, the point B corresponds to the center of the detection unit 20b, and the point D corresponds to a position opposite to the point B in the height direction of the detection unit 20b on an edge of the detection unit 20b in the height direction.

$$θ f = arc tan ( ( Wa / 2 ) / SDD ) \qquad ( 1 )$$

$$θ c = arc tan ( ( Ha / 2 ) / SDD ) \qquad ( 2 )$$

Also, when the width of the imaging region of the detection unit 20b is represented by Wb, the height of the imaging region of the detection unit 20b is represented by Hb, and a distance from the X-ray emitting unit 10 to the rotation center of the subject placement unit 30 is represented by SRD, the control unit 90 is configured to perform control for obtaining the width Wb using the following formula (3) and obtaining the height Hb using the following formula (4).

$$W b = SRD \times sin ( θ f ) \qquad ( 3 )$$

$$Hb = SRD \times sin ( θ c ) \qquad ( 4 )$$

The control unit 90 is configured to perform control for displaying, on the display unit 70, the superimposed image 103b (103c) in which the imaging region image 104b (104c) showing a rectangular imaging region having the width Wb and the height Hb is superimposed on the captured image 101b (101c). Also, the width Wb represents the diameter of a circular imaging region of the case where the subject 200 is viewed from above in a plan view, and accordingly, the control unit 90 is configured to perform control for displaying, on the display unit 70, the superimposed image 103a in which the imaging region image 104a showing the circular imaging region having the radius Wb is superimposed on the captured image 101a.

### Method for Determining Imaging Position

The following describes a method for determining the imaging position in the imaging device 100 according to the present embodiment based on a flowchart with reference to FIG. 11.

First, in step 110, the control unit 90 performs control for capturing an image of the subject 200 with use of the detection unit 20a having the large imaging region. That is to say, the control unit 90 performs control for capturing an image of the subject 200 with use of the detection unit 20a by emitting X-rays 11 from the X-ray emitting unit 10 toward the subject 200 placed on the subject placement unit 30 in the state where the detection unit 20a has been moved by the detection unit moving mechanism 60 such that the optical axis 12 of the X-ray emitting unit 10 coincides with the center of the detection unit 20a, and by detecting X-rays 11 that have passed through the subject 200 with use of the detection unit 20a.

Then, in step 120, the control unit 90 performs control for generating an X-ray image including the captured image 101 of the subject 200 captured with use of the detection unit 20a having the large imaging region. The generated X-ray image may be a projection image (perspective image) of the subject 200 captured at a specific imaging angle, a CT image generated from a plurality of projection images through reconstruction processing, or a tomographic image generated from a CT image, for example. The captured image 101 that is used to generate a superimposed image 103 may be a projection image or a tomographic image.

Assume that a user who checked the X-ray image (captured image 101) of the subject 200 captured using the detection unit 20a having the large imaging region wants to further check a specific part (e.g., the part 201) of the subject 200 included in the X-ray image of the subject 200 captured using the detection unit 20a having the large imaging region, and intends to obtain an image of the specific part, which is an imaging target part, of the subject 200 with use of the detection unit 20b. In this case, in step 130, the control unit 90 performs control for generating the superimposed image 103 by superimposing the imaging region image 104 showing the imaging region of the detection unit 20b on the captured image 101 based on an operation made by the user using the operation unit 80.

Then, in step 140, the control unit 90 performs control for displaying the superimposed image 103 on the display unit 70. Also, if the relative position of the subject 200 relative to the detection unit 20b changes in the state where the superimposed image 103 is displayed on the display unit 70, the control unit 90 performs control for changing the position of the imaging region image 104 on the captured image 101 in the superimposed image 103 so as to track the change in the relative position of the subject 200 relative to the detection unit 20b. The user determines whether or not the imaging target part of the subject 200 is included in the imaging region of the detection unit 20b having the small imaging region based on the superimposed image 103 displayed on the display unit 70, and determines the imaging position.

### Effects of Embodiment

The following effects can be obtained in the present embodiment.

In the present embodiment, the superimposed image 103 is generated by superimposing the imaging region image 104 showing the imaging region of the detection unit 20b on the captured image 101 and the superimposed image 103 is displayed on the display unit 70 as described above. This enables the user to easily grasp whether or not the imaging target part of the subject 200 is included in the imaging region of the detection unit 20b having the small imaging region based on the superimposed image 103 displayed on the display unit 70. Therefore, it is possible to easily determine the imaging position when the detection unit 20a having the large imaging region is switched to the detection unit 20b having the small imaging region to capture an image of the subject 200.

Also, if the imaging target part of the subject 200 is not included in the captured image 102, it is difficult to find the imaging target part of the subject from the captured image 102, and accordingly, it is difficult to determine the imaging position. However, in the present embodiment, the imaging position can be easily determined as described above because the superimposed image 103 is displayed on the display unit 70, and this is very effective when the imaging target part of the subject 200 is not included in the captured image 102.

Also, in the present embodiment, the control unit 90 performs control for changing the position of the imaging region image 104 on the captured image 101 in the superimposed image 103 so as to track a change in the relative position of the subject 200 relative to the detection unit 20b as described above. Accordingly, if the relative position of the subject 200 relative to the detection unit 20b changes while the imaging position is adjusted, the change in the relative position of the subject 200 relative to the detection unit 20b can be reflected in the position of the imaging region image 104 on the captured image 101 in the superimposed image 103. Therefore, the user can more easily grasp whether or not the imaging target part of the subject 200 is included in the imaging region of the detection unit 20b having the small imaging region based on the superimposed image 103 displayed on the display unit 70. This further facilitates determination of the imaging position.

Also, in the present embodiment, the subject placement unit 30 that is movable and can have the subject 200 thereon is provided and the control unit 90 performs control for changing the position of the imaging region image 104 on the captured image 101 in the superimposed image 103 so as to track a change in the relative position of the subject 200 relative to the detection unit 20b due to the movement of the subject placement unit 30 accompanied by the movement of the subject 200 as described above. Accordingly, if the subject placement unit 30 is moved while the imaging position is adjusted, a change in the relative position of the subject 200 relative to the detection unit 20b due to the movement of the subject placement unit 30 can be reflected in the position of the imaging region image 104 on the captured image 101 in the superimposed image 103. This facilitates a series of operations for adjusting and determining the imaging position.

Also, in the present embodiment, the detection unit 20a and the detection unit 20b are configured to capture images of the subject 200 at equivalent height positions 21 as described above. This facilitates positioning between the captured image 101 and the captured image 102 in the generation of the superimposed image 103, and therefore, it is possible to easily generate the superimposed image 103 in which the imaging region image 104 is superimposed on the captured image 101.

Also, in the present embodiment, the resolution of the detection unit 20b is higher than the resolution of the detection unit 20a as described above. Therefore, when it is desired to capture an image of a relatively large region, it is possible to obtain the captured image 101 with the large imaging region, and when it is desired to obtain an image with a relatively high resolution, it is possible to obtain the captured image 102 with the high resolution. Thus, the captured image 101 and the captured image 102 can be selectively used as appropriate depending on the situations, and this improves convenience. For example, if the captured image 101 with the large imaging region has been obtained and the obtained captured image 101 includes a part of concern (e.g., a part that appears to be a wound), it is possible to obtain the captured image 102 with the high resolution and examine the part of concern in detail in the captured image 102.

Also, in the present embodiment, the captured image 101 is a tomographic image and the control unit 90 performs control for displaying, on the display unit 70, the superimposed image 103 in which the imaging region image 104 having a shape corresponding to a cross section shown by the tomographic image as the captured image 101 is superimposed on the captured image 101 as described above. Accordingly, when the captured image 101 is a tomographic image, it is possible to display, on the display unit 70, the superimposed image 103 in which the imaging region image 104 having an appropriate shape corresponding to the cross section by the tomographic image as the captured image 101 is superimposed on the captured image 101. Therefore, when the captured image 101 is a tomographic image, the user can easily grasp whether or not the imaging target part of the subject 200 is included in the imaging region of the detection unit 20b having the small imaging region based on the superimposed image 103 displayed on the display unit 70.

### Variations

The disclosed embodiment is an illustrative example in all aspects and should not be considered as restrictive. The scope of the present invention is defined not by the above descriptions but by the claims, and encompasses all modifications (variations) within the meanings and scope that are equivalent to the claims.

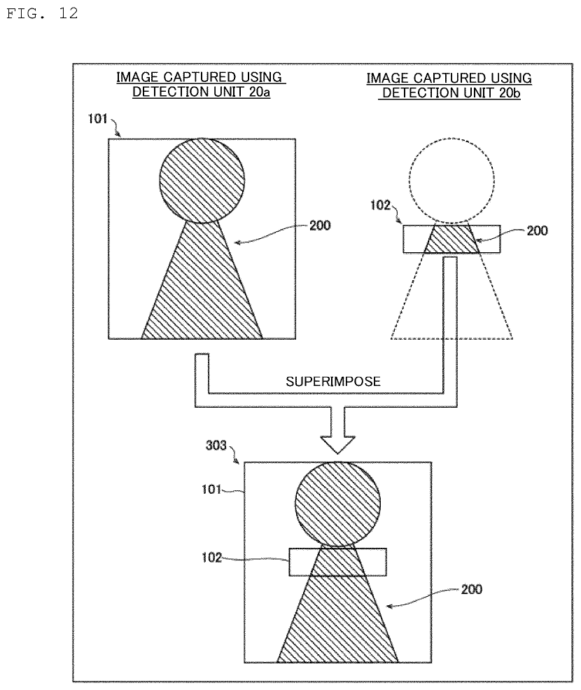

For example, in the above embodiment, an example is described in which the superimposed image 103 is generated by superimposing the imaging region image 104 on the captured image 101, but the present invention is not limited to this example. In the present invention, it is also possible to generate a superimposed image 303 by superimposing the captured image 102 on the captured image 101 as in a variation shown in FIG. 12. The superimposed image 303 is an example of an “X-ray image superimposed image” in the claims.

In this variation, the control unit 90 is configured to perform control for generating the superimposed image 303 by superimposing the captured image 102 on the imaging region of the detection unit 20b in the captured image 101, and perform control for displaying the superimposed image 303 on the display unit 70. This makes is possible to easily grasp whether or not the imaging target part of the subject 200 is included in the imaging region of the detection unit 20b having the small imaging region based on the superimposed image 303 displayed on the display unit 70. Therefore, it is possible to easily determine the imaging position when the detection unit 20a having the large imaging region is switched to the detection unit 20b having the small imaging region to capture an image of the subject 200. Note that the control unit 90 may be configured to be capable of generating both the superimposed image 103 and the superimposed image 303, or the control unit 90 may be configured to be capable of generating only one of the superimposed images 103 and 303.

In the variation, the control unit 90 may be configured to perform control for changing the position of the captured image 102 on the captured image 101 in the superimposed image 303 so as to track a change in the relative position of the subject 200 relative to the detection unit 20b. In this case, the control unit 90 may be configured to perform control for changing the position of the captured image 102 on the captured image 101 in the superimposed image 303 so as to track a change in the relative position of the subject 200 relative to the detection unit 20b due to movement of the subject placement unit 30 accompanied by movement of the subject 200.

Also, in the variation, the control unit 90 may be configured to perform control for displaying the superimposed image 303 on the display unit 70 while capturing images of the subject 200 with use of the detection unit 20b. In this case, the control unit 90 may be configured to perform control for updating the captured image 102 on the captured image 101 in the superimposed image 303 in real time so as to track a change in the relative position of the subject 200 relative to the detection unit 20b as well 1 as performing control for changing the position of the captured image 102 on the captured image 101 in the superimposed image 303 in real time so as to track the change in the relative position of the subject 200 relative to the detection unit 20b.

Also, in the above embodiment, an example is described in which the relative position of the subject 200 relative to the detection unit 20b (second detection unit) changes due to movement of the subject placement unit 30 accompanied by movement of the subject 200, but the present invention is not limited to this example. In the present invention, the relative position of the subject relative to the second detection unit may change due to movement of the second detection unit. Alternatively, the relative position of the subject relative to the second detection unit may change due to movement of both the subject placement unit and the second detection unit.

In the above embodiment, an example is described in which the detection unit 20a (first detection unit) and the detection unit 20b (second detection unit) are configured to capture images of the subject 200 at equivalent height positions 21, but the present invention is not limited to this example. In the present invention, the first detection unit and the second detection unit may be configured to capture images of a subject at different height positions.

In the above embodiment, an example is described in which the imaging device 100 includes the display unit 70, but the present invention is not limited to this example. In the present invention, a configuration is also possible in which the imaging device does not include the display unit. A superimposed image may also be displayed on a display unit that is not included in the imaging device.

### Modes

Those skilled in the art will understand that the illustrative embodiment described above is a specific example of the following modes.

### Item 1

An imaging device including: a first detection unit configured to capture a first X-ray image of a subject;
a second detection unit having an imaging region smaller than an imaging region of the first detection unit and configured to capture a second X-ray image of the subject; and
a control unit,
wherein the control unit performs
control for generating a superimposed image in which an imaging region image showing the imaging region of the second detection unit is superimposed on the first X-ray image, and
control for displaying the superimposed image on a display unit.

### Item 2

The imaging device according to Item 1, wherein the control unit performs control for changing a position of the imaging region image on the first X-ray image in the superimposed image so as to track a change in a relative position of the subject relative to the second detection unit.

### Item 3

The imaging device according to Item 2, further including a subject placement unit that is movable and on which the subject is placeable,
wherein the control unit performs control for changing the position of the imaging region image on the first X-ray image in the superimposed image so as to track a change in the relative position of the subject relative to the second detection unit due to movement of the subject placement unit accompanied by movement of the subject.

### Item 4

The imaging device according to any one of Items 1 to 3, wherein the first detection unit and the second detection unit are configured to capture images of the subject at equivalent height positions.

### Item 5

The imaging device according to any one of Items 1 to 4, wherein the second detection unit has a resolution higher than a resolution of the first detection unit.

### Item 6

The imaging device according to any one of Items 1 to 5, wherein the first X-ray image is a tomographic image, and
the control unit performs control for displaying, on the display unit, the superimposed image in which the imaging region image having a shape corresponding to a cross section shown by the tomographic image as the first X-ray image is superimposed on the first X-ray image.

### Item 7

The imaging device according to any one of Items 1 to 6, wherein the control unit generates an X-ray image superimposed image in which the second X-ray image is superimposed on the first X-ray image.

### Item 8

A method for determining an imaging position in an imaging device including a first detection unit configured to capture a first X-ray image of a subject and a second detection unit having an imaging region smaller than an imaging region of the first detection unit and configured to capture a second X-ray image of the subject, the method including:

generating a superimposed image by superimposing an imaging region image showing the imaging region of the second detection unit on the first X-ray image; and
displaying the superimposed image on a display unit.

### Item 9

An imaging device including: a first detection unit configured to capture a first X-ray image of a subject; a second detection unit having an imaging region smaller than an imaging region of the first detection unit and configured to capture a second X-ray image of the subject; and
a control unit,
wherein the control unit performs
control for generating a superimposed image in which the second X-ray image is superimposed on the imaging region of the second detection unit in the first X-ray image, and control for displaying the superimposed image on a display unit.

What is claimed is:

1. An imaging device comprising: a first detection unit configured to capture a first X-ray image of a subject;
a second detection unit having an imaging region smaller than an imaging region of the first detection unit and configured to capture a second X-ray image of the subject; and
a control unit,
wherein the control unit performs control for generating a superimposed image in which an imaging region image showing the imaging region of the second detection unit is superimposed on the first X-ray image, and
control for displaying the superimposed image on a display unit.

2. The imaging device according to claim 1, wherein the control unit performs control for changing a position of the imaging region image on the first X-ray image in the superimposed image so as to track a change in a relative position of the subject relative to the second detection unit.

3. The imaging device according to claim 2, further comprising a subject placement unit that is movable and on which the subject is placeable,
wherein the control unit performs control for changing the position of the imaging region image on the first X-ray image in the superimposed image so as to track a change in the relative position of the subject relative to the second detection unit due to movement of the subject placement unit accompanied by movement of the subject.

4. The imaging device according to claim 1, wherein the first detection unit and the second detection unit are configured to capture images of the subject at equivalent height positions.

5. The imaging device according to claim 1, wherein the second detection unit has a resolution higher than a resolution of the first detection unit.

6. The imaging device according to claim 1, wherein the first X-ray image is a tomographic image, and
the control unit performs control for displaying, on the display unit, the superimposed image in which the imaging region image having a shape corresponding toa cross section shown by the tomographic image as the first X-ray image is superimposed on the first X-ray image.

7. The imaging device according to claim 1, wherein the control unit generates an X-ray image superimposed image in which the second X-ray image is superimposed on the first X-ray image.

8. A method for determining an imaging position in an imaging device including a first detection unit configured to capture a first X-ray image of a subject and a second detection unit having an imaging region smaller than an imaging region of the first detection unit and configured to capture a second X-ray image of the subject, the method comprising:
generating a superimposed image by superimposing an imaging region image showing the imaging region of the second detection unit on the first X-ray image; and
displaying the superimposed image on a display unit.

9. An imaging device comprising: a first detection unit configured to capture a first X-ray image of a subject;
a second detection unit having an imaging region smaller than an imaging region of the first detection unit and configured to capture a second X-ray image of the subject; and
a control unit,
wherein the control unit performs
control for generating a superimposed image in which the second X-ray image is superimposed on the imaging region of the second detection unit in the first X-ray image, and
control for displaying the superimposed image on a display unit.
